(19) United States
(12) Patent Application Publication
(10) Pub. No.: US 2007/0131866 A1
(43) Pub. Date: Jun. 14, 2007

(54) Activated alkali metal rare earth halides and articles using same

(75) Inventors: Alok Mani Srivastava, Niskayuna, NY (US); William Winder Beers, Chesterland, OH (US); Holly Ann Comanzo, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/302,902

(22) Filed: Dec. 14, 2005

(51) Int. Cl. G01T 1/20

(52) U.S. Cl. 250/367

(57) ABSTRACT

Scintillator materials based on certain types of activated alkali metal rare earth halide materials are described. In one embodiment, the material contains CsLaBr₄ with Ce(III) ions substituted for a portion of the La component. The scintillator or other detector materials can be in monocrystalline or polycrystalline form. Radiation detectors that use the scintillators are also described, as are related methods for detecting high-energy radiation.

### STATEMENT REGARDING FEDERALLY SPONSORED RESEARCH & DEVELOPMENT

This invention was made with Government support under contract number N66002-05-D-6012 awarded by the U.S. Government. The Government has certain rights in the invention.

### BACKGROUND

Generally, the invention relates to materials and devices used in the detection of ionizing radiation. More specifically, it relates to scintillator compositions which are especially useful for detecting gamma-rays and X-rays under a variety of conditions.

Many techniques are available for detecting high-energy radiation. Scintillators are of special interest, in view of their simplicity and accuracy. Thus, scintillator crystals are widely used in detectors for gamma-rays, X-rays, cosmic rays, and particles characterized by an energy level of greater than about 1 keV. From such crystals, it is possible to manufacture detectors, in which the crystal is coupled with a light-detection means, i.e., a photodetector. When photons from a radionuclide source impact the crystal, the crystal emits light. The photodetector produces an electrical signal proportional to the number of light pulses received from the crystal and to their intensity. Scintillator crystals are in common use for many applications. Examples include medical imaging equipment, e.g., positron emission tomography (PET) devices, well-logging for the oil and gas industry, and various digital imaging applications.

As those skilled in the art understand, the composition of the scintillator is critical to the performance of the radiation detection equipment. The scintillator must be responsive to X-ray and gamma-ray excitation. Moreover, the scintillator should possess a number of characteristics which enhance radiation detection. For example, most scintillator materials must possess high light output, short decay time, reduced afterglow, high “stopping power”, and acceptable energy resolution. Other properties also may be significant, depending on how the scintillator is used, as mentioned below.

Those skilled in the art are familiar with all of the above properties. In brief, “light output” is the quantity of visible light emitted by the scintillator after being excited by a pulse of the x-ray or gamma-ray. High light output is desirable because it enhances the radiation detector's ability to convert the light into an electric pulse. (The size of the pulse usually indicates the amount of radiation energy).

The term “decay time” refers to the time required for the intensity of the light emitted by the scintillator to decrease to a specified fraction of the light intensity at the time when the radiation excitation ceases. For many applications, such as the PET devices, shorter decay times are preferred because they allow efficient coincidence-counting of gamma-rays. Consequently, scan times are reduce, and the device can be used more efficiently.

The term “afterglow” refers to the light intensity emitted by the scintillator at a specified time (e.g., 100 milliseconds) after the radiation excitation ceases. Afterglow is usually reported as a percentage of the light emitted while the scintillator is excited by the radiation. Reduced afterglow is often advantageous because it results in a sharper image produced by the detector, e.g., one free from image artifacts (“ghost images”).

“Stopping power” is the ability of a material to absorb radiation, and is sometimes referred to as the material's “X-ray absorption” or “X-ray attenuation”. Stopping power is directly related to the density of the scintillator material. Scintillator materials which have high stopping power allow little or no radiation to pass through, and this is a distinct advantage in efficiently capturing the radiation.

The “energy resolution” of a radiation detector refers to its ability to distinguish between energy rays (e.g., gamma-rays) having very similar energy levels. Energy resolution is usually reported as a percentage value, after measurements are taken at a standard radiation emission energy for a given energy source. Lower energy resolution values are very desirable, because they usually result in a higher quality radiation detector.

A variety of scintillator materials which possess most or all of the above properties have been in use over the years. For example, thallium-activated sodium iodide (NaI(Tl)) has been widely employed as a scintillator for decades. Crystals of this type are relatively large and fairly inexpensive. Moreover, NaI(TI) crystals are characterized by a very high light output.

Examples of other common scintillator materials include bismuth germanate (BGO), cerium-doped gadolinium orthosilicate (GSO), and cerium-doped lutetium orthosilicate (LSO). Each of these materials has some good properties which are suitable for certain applications.

As those familiar with scintillator technology understand, all of the conventional materials possess one or more deficiencies, along with their attributes. For example, thallium-activated sodium iodide is a very soft, hygroscopic material, readily absorbing oxygen and moisture. Moreover, such a material produces a large and persistent after-glow, which can interfere with the intensity-counting system. Furthermore, the decay time of NaI(Tl), about 230 nanoseconds, is too slow for many applications. The thallium component may also require special handling procedures, in view of health and environmental issues.

BGO, on the other hand, is non-hygroscopic. However, the light yield of this material (15% of NaI(Tl)) is too low for many applications. This material also has a slow decay time. Moreover, it has a high refractive index, which results in light loss due to internal reflection.

While GSO crystals are suitable for some applications, their light yield is only about 20% of that obtained with NaI(Tl). Moreover, the crystals are easily cleaved. It is therefore very difficult to cut and polish these crystals into any specific shape, without running the risk of fracturing the entire crystal.

The LSO materials also exhibit some drawbacks. For example, the lutetium element of the crystal contains a small amount of a natural, long-decay radioactive isotope, Lu¹⁷⁶. The presence of this isotope will provide a background count rate that can greatly interfere with highly-sensitive detector applications. Moreover, lutetium is very expensive, and has a relatively high melting point, which can sometimes make processing difficult.

Deficiencies of conventional scintillators have prompted the search for new materials. Some of the new materials are described in two publications attributed to P. Dorenbos et al.: International Publication Nos. WO 01/60944 and WO 01/60945. These references describe the use of cerium-activated lanthanide-halide compounds as scintillators. The '944 publication describes the use of Ce-activated lanthanide chloride compounds, while the '945 publication describes the use of Ce-activated lanthanide bromide compounds. The halide-containing materials are said to simultaneously provide a combination of good energy resolution and low decay constants. Such a combination of properties can be advantageous for some applications. Moreover, the publications disclose that the materials exhibit acceptable light output values. Furthermore, the materials are free of lutetium, and the problems sometimes caused by that element.

The Dorenbos publications seem to disclose an advance in scintillator technology. However, such an advance is made against a background of ever-increasing requirements for the scintillator crystals. One example of an end use which has rapidly become more demanding is well-logging. In brief, scintillator crystals are typically enclosed in tubes or casings, forming a crystal package. The package includes an associated photomultiplier tube, and is incorporated into a drilling tool which moves through a well bore.

The scintillation element functions by capturing radiation from the surrounding geological formation, and converting that energy into light. The generated light is transmitted to the photo-multiplier tube. The light impulses are transformed into electrical impulses. Data based on the impulses may be transmitted “up-hole” to analyzing equipment, or stored locally. It is now common practice to obtain and transmit such data while drilling, i.e., “measurement while drilling” (MWD).

One can readily understand that scintillator crystals used for such an application must be able to function at very high temperatures, as well as under harsh shock and vibration conditions. The scintillator material should therefore have a maximized combination of many of the properties discussed previously, e.g., high light output and energy resolution, as well as fast decay times. The scintillator must also be small enough to be enclosed in a package suitable for a constrained space. The threshold of acceptable properties has been raised considerably as drilling is undertaken at ever greater depths. For example, the ability of conventional scintillator crystals to produce strong light output with high resolution can be imperiled as drilling depth is increased.

Furthermore, due to increased terrorist activity, there is a need for practical and high resolution gamma-and neutron-radiation detectors which can detect radioactive “dirty bombs” and other sources of radiation. In addition, hand held or portable devices including, for example, Hand Held Radioisotope Identification Devices (HHRIID's) are in high demand. Newer standards such as ANSI N42.33 (Type I) and ANSI N42.34 have also been specified due to the increased performance demands.

The typical approaches to gamma-radiation spectroscopy utilize NaI, CsI, Cadmium Zinc Telluride (CZT), Bismuth Germanate (BGO), or High Purity (HP) Germanium as direct-detection or scintillator materials. A desirable radiation detector able to simultaneously detect gamma- and neutron-radiation should demonstrate improved functionality and identification performance, i.e., it should be able to distinguish if suspect radiation is related to Naturally Occurring Radioactive Materials (NORM), Special Nuclear Materials (SNM), medical sources, industrial isotopes, or a combination thereof, should be easily deployable, and should have low total cost of ownership.

Improved identification performance relies heavily on energy resolution, for which a HP Ge-based detector would have nearly ideal characteristics. However, the need for cryogenic cooling, and materials cost in this type of detector severely impacts functionality, deployment, and total cost of ownership. Other materials solutions, such as NaI, CsI(Tl) or CsI(Na), or CZT, suffer from low energy resolution, high price, and/or inability to obtain sufficiently large volumes, which will also preclude meeting the above mentioned requirements and/or U.S. Homeland Security requirements for HHRIID's.

The problem has generally been addressed by separating the gamma and neutron components into two separate detector materials. Most of the existing combinations of simultaneous gamma- and neutron-detectors use materials combinations that do not allow adequate identification, are not easily deployable, and/or have high total cost of ownership.

It is thus clear that new scintillator materials are needed, if they could satisfy the ever-increasing demands for commercial and industrial use. The materials should exhibit excellent light output, as well as relatively fast decay times. They should also possess good energy resolution characteristics, especially in the case of gamma-rays. Moreover, the new scintillators should be readily transformable into monocrystalline materials or other transparent solid bodies. Furthermore, they should be capable of being produced efficiently, at reasonable cost and acceptable crystal size. The scintillators should also be compatible with a variety of high-energy radiation detectors, such as combined neutron- and gamma-radiation detectors.

### SUMMARY

In accordance with one embodiment of the invention, an activated alkali metal rare earth halide material is described, particularly for use in sensing elements and radiation detectors. In one aspect, the activated alkali metal rare earth halide has the formula A[RE]X₄:T, where A is an alkali metal, [RE] is a rare earth element, X is a halogen, and T is an activator element. In one preferred embodiment, the activated alkali metal rare earth halide material comprises a cerium-activated cesium lanthanum bromide, such as CsLa_{0.95}Ce_{0.05}Br₄.

In accordance with another embodiment of the invention, a sensing element activated by radiation can comprise: (a) a first scintillator activated by gamma-radiation; and (b) a neutron-sensing layer comprising a second scintillator activated by neutron radiation. In one aspect, the first scintillator comprises an activated alkali metal rare earth halide having the formula A[RE]X₄:T, where A is an alkali metal, [RE] is a rare earth element, X is a halogen, and T is an activator element.

In accordance with another embodiment of the invention, a radiation detector capable of detecting both gamma-rays and neutrons can comprise: (a) a radiation-sensing element comprising a gamma-radiation-sensing first scintillator and a neutron-sensing second scintillator; and (b) a photosensor. In one aspect, the gamma-radiation-sensing first scintillator comprises an activated alkali metal rare earth halide having the formula A[RE]X₄:T, where A is an alkali metal, [RE] is a rare earth element, X is a halogen, and T is an activator element.

### DRAWINGS

These and other features, aspects, and advantages of the present invention will become better understood when the following detailed description is read with reference to the accompanying drawings in which like characters represent like parts throughout the drawings, wherein:

FIG. 1 shows a perspective view of an integrated detector system optically coupling two scintillators together constructed in accordance with an exemplary embodiment of the invention.

FIG. 2 shows a perspective view of a detector having wavelength shifting fibers constructed in accordance with an exemplary embodiment of the invention.

FIG. 3 illustrates an aspect of a detector having two scintillators that are not optically coupled.

FIG. 4 illustrates an aspect of a detector having a moderator to thermalize neutrons before detection.

FIG. 5 illustrates an aspect of a detector having a single wavelength-shifting fiber.

FIG. 6 shows a perspective view of another detector having wavelength shifting fibers constructed in accordance with an exemplary embodiment of the invention.

FIG. 7 illustrates an aspect of a detector using wavelength shifting fibers.

FIG. 8 illustrates an aspect of a detector having multiple wavelength-shifting fibers.

FIG. 9 illustrates an aspect of a detector that does not include wavelength-shifting fibers.

FIG. 10 illustrates an aspect of a detector that eliminates the optical coupling between scintillators.

FIG. 11 illustrates another aspect of a detector that eliminates the optical coupling between scintillators.

FIG. 12 shows a perspective view of another detector lacking wavelength shifting fibers and in which a second photosensor is placed on the radiation entrance side of the sensor constructed in accordance with an exemplary embodiment of the invention.

FIG. 13 shows a perspective view of another detector lacking wavelength shifting fibers and in which a second photosensor is placed between two scintillators constructed in accordance with an exemplary embodiment of the invention.

FIG. 14 is a graph showing an x-ray emission spectrum for a CsLaBr₄:Ce³⁺ gamma-scintillator composition under UV excitation.

### DETAILED DESCRIPTION

One aspect of the invention relates to a solid, crystalline form of an activated alkali metal rare earth halide material having the general formula A[RE]X₄:T, where A is an alkali metal, RE is a rare earth element, X is a halogen, and T is an activator or a dopant element. The solid, crystalline materials can include a single phase or multiple phases. (Those skilled in the art understand that phase transitions may occur within a crystal after its formation, e.g., after subsequent processing steps like sintering or densification). These materials can be particularly useful as scintillator materials.

Alkali metals include, but are not limited to, lithium, sodium, potassium, rubidium, cesium, and combinations thereof. One preferred alkali metal is cesium.

Rare earth elements can include, but are not limited to: lanthanides such as lanthanum, cerium, praseodymium, neodymium, promethium, samarium, europium, gadolinium, terbium, dysprosium, holmium, erbium, thulium, ytterbium, and lutetium; yttrium; and combinations thereof. For the purpose of this disclosure, yttrium is also considered to be a part of the family of lanthanides or rare earth elements, and those skilled in the art understand that yttrium is closely associated with the rare earth group. Preferred rare earth elements are yttrium, gadolinium, lanthanum, and lutetium. In a preferred embodiment, the rare earth element comprises lanthanum.

Halogens include, but are not limited to, fluorine, bromine, chlorine, iodine, and combinations thereof. In one preferred embodiment, the halogen is bromine.

As mentioned above, the solid, crystalline material further includes an activator (sometimes referred to as a dopant). Trivalent activators can include, but are not limited to, cerium, bismuth, thallium, a rare earth element, or a combination thereof. Any rare earth activators present will be different than the rare earth element disclosed above. In terms of luminescence efficiency and decay time, a preferred activator contains cerium.

The amount of activator present will depend on various factors, such as the particular alkali metal rare earth halide being used; the desired emission properties and decay time; and the type of detection device into which the scintillator is being incorporated. Usually, the activator is employed at a level from about 0.1 mol % to about 20 mol %, based on total moles of activator and alkali metal rare earth halide material. In many preferred embodiments, the amount of activator is in the range from about 1 mol % to about 10 mol %. These molar percentages apply to the addition of any and all activators, whether one or more than one is present in the alkali metal rare earth halide. These molar percentages of activator typically correspond (with adjustments for relative valence, if necessary) to the deviation from stoichiometry of the rare earth element component. In other words, when both the rare earth element and the activator are trivalent, for example, the sum of their molar percentages should be 100%.

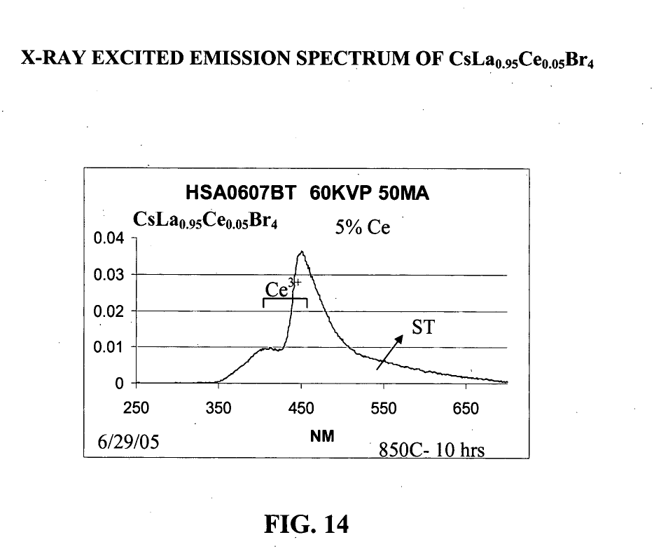

In one preferred embodiment, the alkali metal rare earth halide material is cesium lanthanum bromide doped with cerium and optionally bismuth. FIG. 14 shows an x-ray excited emission spectrum, plotting wavelength (nm) as a function of intensity (arbitrary units), for a cesium lanthanum bromide doped with about 5 mol % cerium (CsLa_{0.95}Ce_{0.05}Br₄). The spectrum indicates the activation of the alkali metal rare earth halide with cerium, which results in a comparable light output (efficiency) as compared to existing scintillator crystalline materials such as cerium-activated lanthanum halides. Such activated lanthanum halide materials are disclosed, for example, in commonly-owned co-pending U.S. Patent Application Publication No. US 2005/0082484 A1, the entire contents of which are incorporated herein by reference.

Cerium-doped cesium lanthanum bromide materials compare favorably to other scintillator compositions in terms of light output, efficiency, and attenuation length, despite being noticeably less dense. For example, crystals of cerium-doped cesium lanthanum bromide can exhibit a light output of approximately 64,000 protons/MeV, which is approximately 7 times greater than that of bismuth germanate (BGO) and about 2 ½ times greater than that of lutetium orthosilicate (LSO). In addition, cerium-doped cesium lanthanum bromide materials can exhibit an attenuation length (Z_{eff}/ρ) comparable to BGO and LSO, despite being considerably less dense (ρ_{CLB:Ce}˜4-5 g/cc, compared to ρ_{BGO},ρ_{LSO}>7 g/cc). Furthermore, cerium-doped cesium lanthanum bromide materials can exhibit a scintillator efficiency as low as about 3-4%, which is comparable to cerium-doped lanthanum halides and noticeably better than standard thallium-doped sodium iodide (only about 7%).

The composition of embodiments of the invention may be prepared in several different forms. In some preferred embodiments, the composition is in monocrystalline (i.e., “single crystal”) form. Monocrystalline scintillation crystals have a greater tendency for transparency. They are especially useful for high-energy radiation detectors, e.g., those used for gamma-rays.

However, the composition can be in other forms as well, depending on its intended end use. For example, it can be in powder form. It can also be prepared in the form of a polycrystalline ceramic. It should also be understood that the scintillator compositions may contain small amounts of impurities, such as those described in previously-referenced International Publication Nos. WO 01/60944 and WO 01/60945, the disclosures of each of which are hereby incorporated by reference. These impurities usually originate with the starting materials, and typically constitute less than about 0.1% by weight of the scintillator composition. Very often, they constitute less than about 0.01% by weight of the composition. The composition may also include parasite phases, whose volume percentage is usually less than about 1%. Moreover, minor amounts of other materials may be purposefully included in the scintillator compositions, for example, as taught in U.S. Pat. No. 6,585,913, which is also incorporated herein by reference.

In most embodiments where a single crystal is desired, the crystal can be formed from the molten composition by a suitable technique. A variety of techniques may be employed. They are described in many references, such as U.S. Pat. No. 6,437,336; “Crystal Growth Processes”, by J. C. Brice, Blackie & Son Ltd (1986); and the “Encyclopedia Americana”, Volume 8, Grolier Incorporated (1981), pages 286-293. These descriptions are incorporated herein by reference. Non-limiting examples of the crystal-growing techniques are the Bridgman-Stockbarger method; the Czochralski method, the zone-melting method (or “floating zone” method); and the temperature gradient method. Those skilled in the art are familiar with the necessary details regarding each of these processes.

Another embodiment of the invention is directed to a method for detecting high-energy radiation with a scintillation detector. The detector can include one or more crystals, formed from the scintillator composition described herein. Scintillation detectors are well-known in the art, and need not be described in detail here. Several references (of many) which discuss such devices include, for example, U.S. Pat. Nos. 6,585,913, 6,437,336, and 6,624,420, the disclosures of all of which are incorporated herein by reference. In general, the scintillator crystals in these devices receive radiation from a source being investigated, and produce photons which are characteristic of the radiation. The photons are detected with some type of photodetector. (The photodetector is connected to the scintillator crystal by conventional electronic and mechanical attachment systems).

As mentioned above, the photodetector can be a variety of devices, all well-known in the art. Non-limiting examples include photomultiplier tubes, photodiodes, CCD sensors, and image intensifiers. Choice of a particular photodetector will depend in part on the type of radiation detector being fabricated, and on its intended use.

The radiation detectors themselves, which include the scintillator and the photodetector, can be connected to a variety of tools and devices, as mentioned previously. Non-limiting examples include well-logging tools and nuclear medicine devices (e.g., PET). The radiation detectors may also be connected to digital imaging equipment, e.g., pixilated flat panel devices. Moreover, the scintillator may serve as a component of a screen scintillator. For example, powdered scintillator material could be formed into a relatively flat plate which is attached to a film, e.g., a photographic film. High energy radiation, e.g., X-rays, originating from some source, would contact the scintillator and be converted into light photons, which are developed on the film.

Several of the preferred end use applications should also be briefly discussed. Well-logging devices were mentioned previously, and represent an important application for these radiation detectors. The technology for operably connecting the radiation detector to a well-logging tube is well-known in the art. Some general concepts are described in U.S. Pat. No. 5,869,836, which is incorporated herein by reference. The crystal package containing the scintillator usually includes an optical window at one end of the enclosure-casing. The window permits radiation-induced scintillation light to pass out of the crystal package for measurement by the light-sensing device (e.g. the photomultiplier tube), which is coupled to the package. The light-sensing device converts the light photons emitted from the crystal into electrical pulses that are shaped and digitized by the associated electronics. By this general process, gamma-rays can be detected, which in turn provides an analysis of the rock strata surrounding the drilling bore holes.

Medical imaging equipment, such as the PET devices mentioned above, represent another important application for these radiation detectors. The technology for operably connecting the radiation detector (containing the scintillator) to a PET device is also well-known in the art. Some general concepts are described in references such as U.S. Pat. No. 6,624,422, which is incorporated herein by reference. In brief, a radiopharmaceutical is usually injected into a patient, and becomes concentrated within an organ of interest. Radionuclides from the compound decay and emit positrons. When the positrons encounter electrons, they are annihilated and converted into photons, or gamma-rays. The PET scanner can locate these “annihilations” in three dimensions, and thereby reconstruct the shape of the organ of interest for observation. The detector modules in the scanner usually include a number of “detector blocks”, along with the associated circuitry. Each detector block may contain an array of the scintillator crystals, in a specified arrangement, along with photomultiplier tubes.

In both the well-logging and PET technologies, the light output of the scintillator is critical. Embodiments of the invention provide scintillator materials which can provide the desired light output for demanding applications of the technologies. Moreover, the crystals can simultaneously exhibit the other important properties noted above, e.g., short decay time, reduced afterglow, high “stopping power”, and acceptable energy resolution. Furthermore, the scintillator materials can be manufactured economically, and can also be employed in a variety of other devices which require radiation detection.

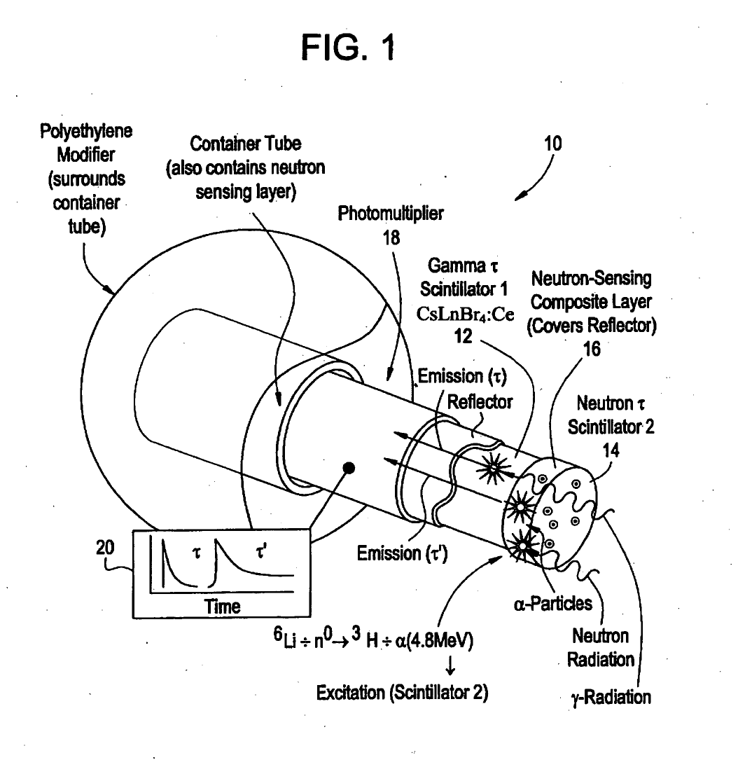

FIG. 1 shows a first embodiment which represents a first integrated sensor approach, i.e., optically coupling two scintillators as compared to a second approach having separated sensors discussed subsequently below at the SECOND APPROACH section. See also commonly-assigned, co-pending U.S. application Ser. No. 11/160,500, filed Jun. 27, 2000, entitled “Gamma and Neutron Radiation Detector,” the entire contents of which are incorporated herein by reference.

### FIRST APPROACH

In one version of the first approach shown in FIG. 1, a method and system for a detector allowing simultaneous detection of gamma- and neutron-radiation using a single sensing element 10 with optical coupling between two scintillators (12, 14) and a dual material approach is introduced.

Specifically, the gamma- and neutron-detector described in FIG. 1 makes use of two different light emitting scintillator materials (12,14) (one for gamma detection 12 and one for neutron detection 14), a photosensor (see photomultiplier (PMT) 18), and electronics (not shown). When radiation collides with the scintillators, light is emitted and detected by the photosensor.

The electronics process electronic signals from the photosensor, and thereby determine whether a given event is indicative of a gamma-ray or a neutron-radiation. In the case of gamma-rays, the electronics also determine the energy of the gamma ray based on the amount of charge generated in the photosensor. The scintillators (12, 14) are specifically chosen so that they have different response times, making it possible to discriminate between gamma- and neutron-radiation based on pulse-shape analysis. In FIG. 1, the sensing element 10 may include a first trivalently-doped alkali metal rare earth halide (A[RE]X₄:T) scintillator material 12, with characteristic primary speed τ, that is able to detect gamma-radiation. Additionally, a neutron-sensing composite layer 16 is coupled to a photomultiplier tube (PMT) 18. The neutron-sensing composite layer 16 contains both elements with high neutron cross-section and a second scintillator 14 designed to scintillate with primary speed τ′, which is different from the first scintillator 12.

Thus, as shown in FIG. 1, this system will use a dual material approach, comprising a first scintillator 12 with characteristic primary speed, τ, able to detect γ-radiation. Also included is a neutron-sensing composite layer 14, and both are coupled to a PMT 18. The neutron sensing composite layer 14 is formed by elements with high neutron cross-sections that are selected to yield alpha particles according to the nuclear reaction associated to the particular element(s) chosen, and a dispersion of a second scintillator 14 with a characteristic primary speed, τ′. This neutron-sensing composite layer 14 is virtually transparent to incoming γ-radiation, which will be collected by the first scintillator 12 and detected by the same PMT 18 with its own characteristic primary speed, τ. Using proven pulse discrimination methods to take advantage of the difference in primary speed (τ≠τ′) between the scintillators, this dual material approach simultaneously detects both γ- and neutron-radiation with a single photosensor and electronics package. This embodiment is aided by the development and optimization of a novel class of trivalently-doped alkali metal rare earth halide γ-scintillator materials, which have outstanding energy resolution that will consequently enable high-preformance room temperature detectors at considerably lower cost, when compared to current technologies such as cryogenically cooled high purity germanium (HP Ge).

Significantly, the illustrated embodiment may use trivalently-doped alkali metal rare earth halides (A[RE]X₄:T) which have outstanding physical properties (high light output, high scintillation efficiency, high energy resolution) and enable a high-preformance detector at considerably lower cost when compared to current detection technologies such as high purity germanium (HP Ge). The illustrated embodiment also may be used at room temperatures without cryogenic cooling, making it ideal for portable or hand held detectors. The neutron-sensing composite layer 16 will use currently available materials, and will be integrated into a photodetection system composed of off the shelf PMT 18 and electronic components.

### NEUTRON DETECTION

Neutron radiation detection is generally carried out using proven technologies such as He or BF₃ gaseous proportional counters. Gas-based detectors are limited in terms of packaging and sensitivity, thus are not practical for applications such as HHRIIDs. Here, as shown in FIG. 1, a different approach is proposed allowing detection and discrimination using the same photosensor and electronics package as used for the γ-radiation detection. Neutron-capture and subsequent detection is accomplished by using a neutron-sensitive composite layer 16 mounted between the first γ-scintillator 12 and the detector cap. As previously stated, this layer 16 is selected to contain element(s) with high neutron cross-section which are able to generate high-energy particles as a result of the nuclear reaction, and be virtually transparent to incoming γ-radiation. In addition, the neutron-sensing composite layer 16 will contain a second scintillator material 14 that will capture the resulting high-energy alpha particles and convert their energy to luminescence that will be detected by the PMT 18. The second scintillator 12 should have low density, emit where the PMT is sensitive (e.g., from about 300 to about 500 nm), not excite the trivalently-doped alkali metal rare earth halide emission nor be excited by the trivalently-doped alkali metal rare earth halide emission, and have a primary speed sufficiently different from that of the first γ-scintillator 12. A suitable system is the commercially available 6LiF/ZnS:Ag composite that makes use of the 6Li+n⁰->3H+α(4.8 MeV) reaction, resulting in an emission at about 450 nm with about 80 μs decay time (see also the decay time diagram 20).

### SECOND APPROACH

A second approach involves separating and not optically coupling the two scintillators (12, 14), which effectively separates the detectors from each other. This approach describes methods and geometries for avoiding problems caused by optical absorption of the scintillation photons from one scintillator in the other scintillator in detection systems which require two scintillators. Possible problems with optical absorption are avoided by eliminating the need to have the two scintillators optically coupled to each other. In some of the contemplated embodiments, detection may be achieved either by coupling one of the scintillators to wavelength-shifting fibers which transport the signal to a single photosensor (which also directly receives photons from the second scintillator) or by incorporating a second photosensing element, such as a photodiode.

This second approach has the advantage of greatly reducing the requirements on the emission and absorption spectra of the two scintillators, thereby increasing the number of possible scintillators which can be used for each of the functions (gamma- and neutron-detection).

This approach contrasts to the first approach shown in FIG. 1, wherein two scintillators (12, 14) are used, and the scintillators are optically linked or combined in an overall sensing element 10 to achieve detection of both gamma- and neutron-radiation. In the second approach, the two scintillators are optically coupled to each other and to a photosensing element 18. This approach may have performance limitations if either of the scintillators have optical absorption within the wavelength range of the emission from the other scintillator. If this happens, the absorption of the scintillation photons from one or both of the scintillators may reduce the number of photons that are detected and may also make the number of photons detected for each event (gamma- or neutron-absorption) more dependent on the position of interaction of the radiation within the scintillators. Additionally, a reduction in the number of scintillation photons detected will reduce the signal-to-noise ratio, resulting in degraded energy resolution (for gamma-rays) and reduced ability to discriminate between gamma- and neutron-radiation. An increase in the variation in the detected signal as a function of interaction position will also degrade the energy resolution of the detector (for gamma-rays) and may degrade the discrimination function. Therefore, as discussed above, the first approach works very well but requires that suitable scintillators be used.

Therefore, the second approach overcomes the need for optical coupling between the two scintillators by using novel design concepts.

Two general classes of design modifications are described below as follows: 1) the use of wavelength-shifting fiber to couple one of the scintillators to the photosensor while directly coupling the second scintillator to the photosensor; or 2) the use of a second photosensor, such as a photodiode, to readout the second scintillator.

The modifications for the two classes of designs (Class 1 and Class 2) are described below:

Class 1

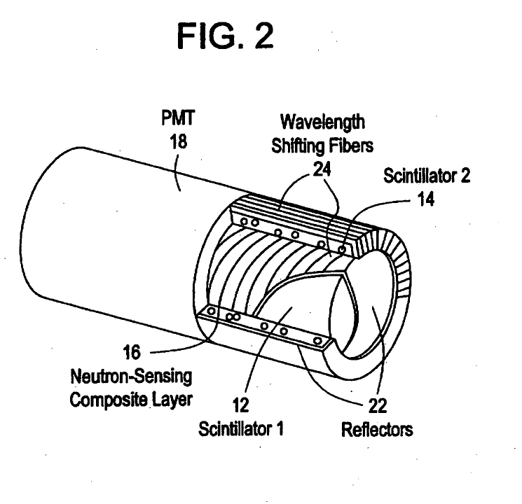

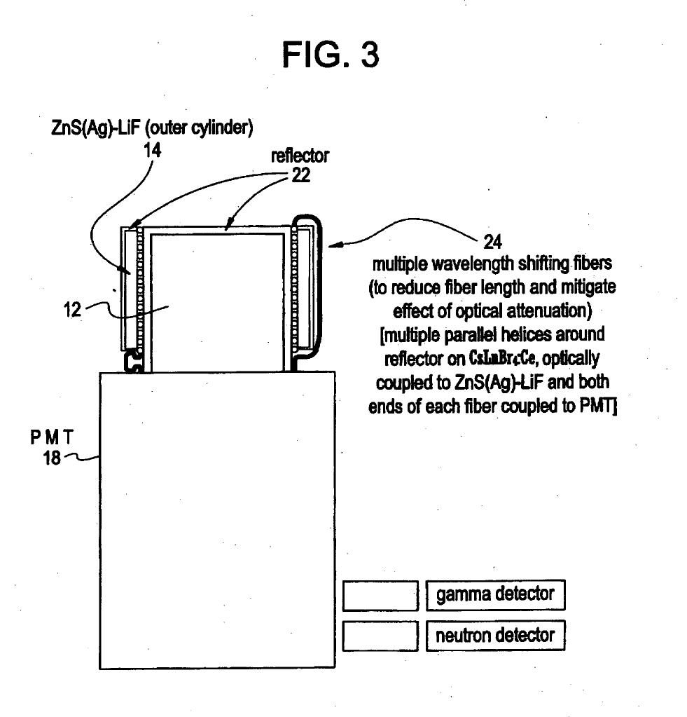

As first shown in the embodiment of FIGS. 2 and 3, in Class 1 designs, one scintillator, in this case the first scintillator 12, is coupled directly to the photosensor (a photomultiplier tube (PMT) 18, for example), and the remaining surfaces of the scintillator 12 are covered with an appropriate reflecting material 22 (to improve the light collection efficiency). The second scintillator 14 is in this case located radially and is coupled (on at least one surface) to wavelength-shifting fibers 24 (with the remaining surfaces covered with an appropriate reflector material). Optical photons emitted from the second scintillator 14 are absorbed by the wavelength-shifting fibers 24. This energy is then re-emitted at a longer wavelength within the fiber. It is noted that the wavelength shift is a natural consequence of the absorption and re-emission process,. A fraction of the re-emitted photons are emitted within the numerical aperture of the fiber, and these photons are guided by the fiber to the photosensor. Several possible embodiments of this design are shown.

FIG. 3 is an example of a design that eliminates the optical coupling between the scintillators. This is a “Class 1” design. The first scintillator 12 is a gamma-scintillator (A[RE]X₄:T, in this case) and is coupled directly to the photosensor (shown as PMT 18). The emission from the second scintillator 14 which is the neutron-scintillator (ZnS[Ag]—LiF, in this case) is absorbed in the wavelength shifting fibers 24 (multiple fibers in an inter-leaving helix) and then the re-emitted photons are guided to the photosensor. Alternatively, light from the neutron-sensing scintillator can be scattered into the fiber, transmitted a distance in the fiber, absorbed in the fiber, and re-emitted and guided to the photosensor. Other fiber geometries other than an inter-leaving helix may also be used, i.e., other fiber geometries that guide light to the photosensor, as would be understood by those skilled in the art, may also be used.

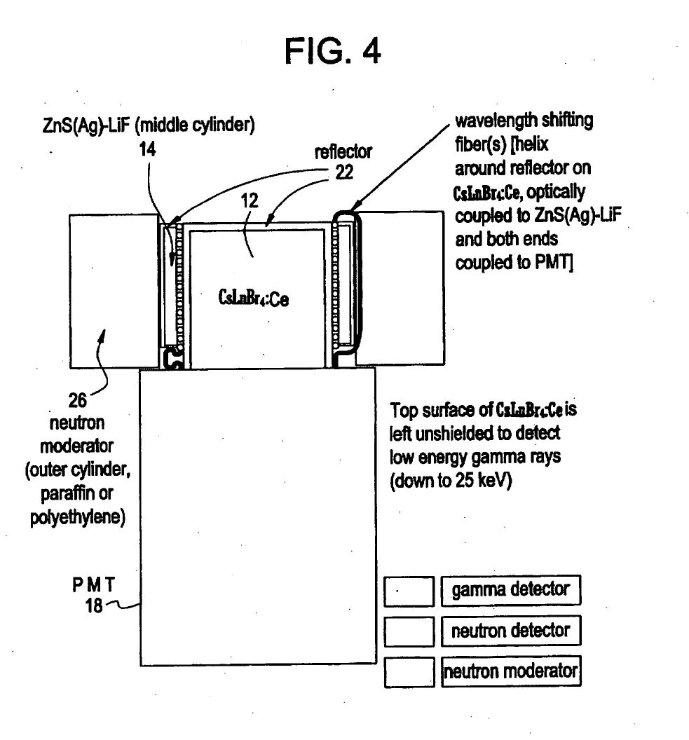

FIG. 4 is an example of a design (“Class 1”) that includes a moderator 26 to thermalize incident neutrons before detection. One surface of the first scintillator 12 (A[RE]X₄:T, in this case) is left uncovered by the moderator 26 so that low energy gamma-rays can be detected without significant attenuation. The moderator could be used with any of the designs in this disclosure.

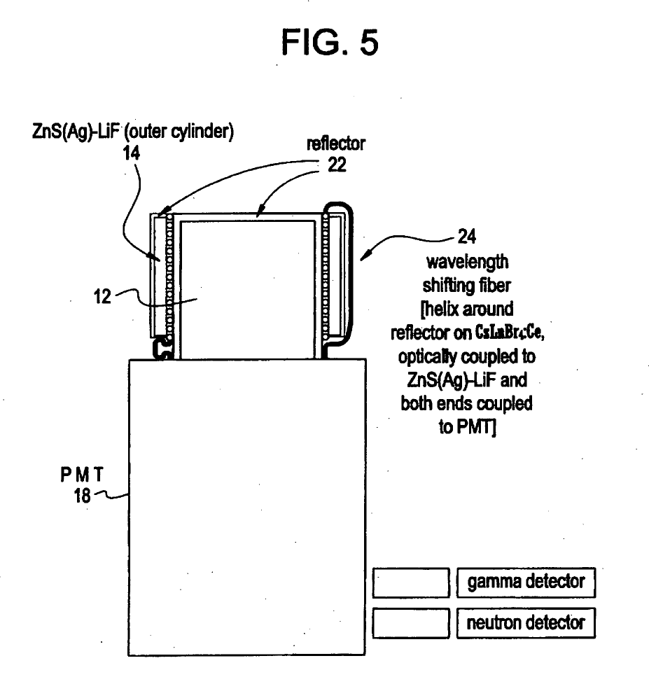

FIG. 5 is a variation on the design (“Class 1”) in FIG. 1. In this case, a single wavelength-shifting fiber 24 is used which is configured in a helix.

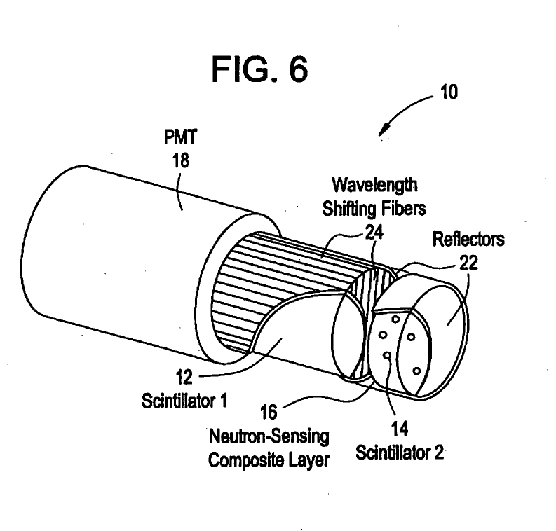

FIG. 6 is a perspective view of an arrangement where the second scintillator 14 is located at the radiation entry end of the overall sensor element 10 and is another variation on the design (“Class 1”) using wavelength shifting fibers 24.

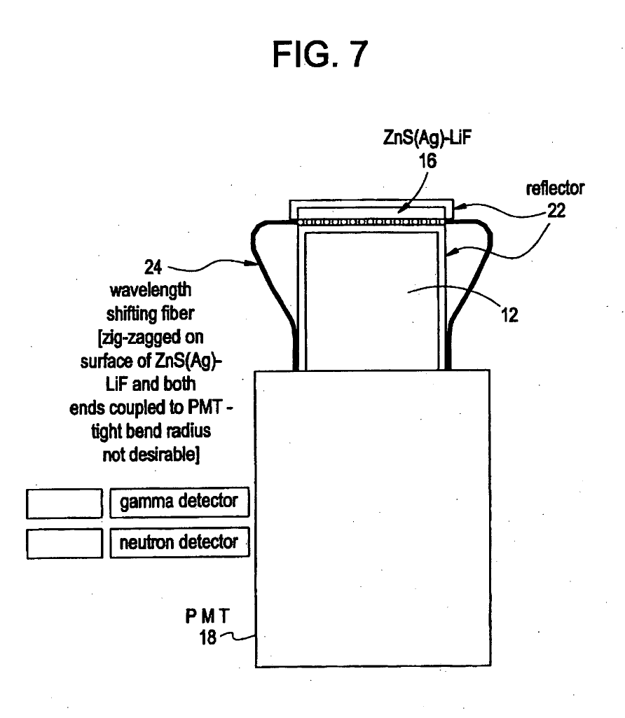

FIG. 7 is another variation on the design (“Class 1”) using wavelength shifting fibers, wherein the wavelength shifting fibers are zigzagged on the surface of ZnS(Ag)—LiF, with both ends coupled to PMT 18.

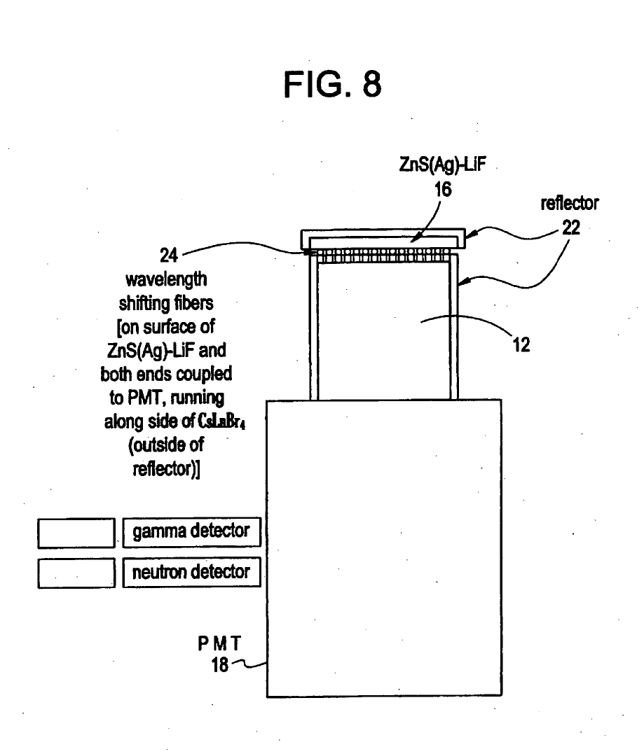

FIG. 8 is a variation on the design (“Class 1”) in FIG. 7. In this case multiple wavelength-shifting fibers 24 are used. The efficiency of the transfer of photons from the neutron scintillator or sensing layer 16 (ZnS[Ag]—LiF, in this case) to the photosensor (PMT 18, in this case) is increased by reducing the total optical path length (by using multiple fibers) and by eliminating any tight bends in the fibers.

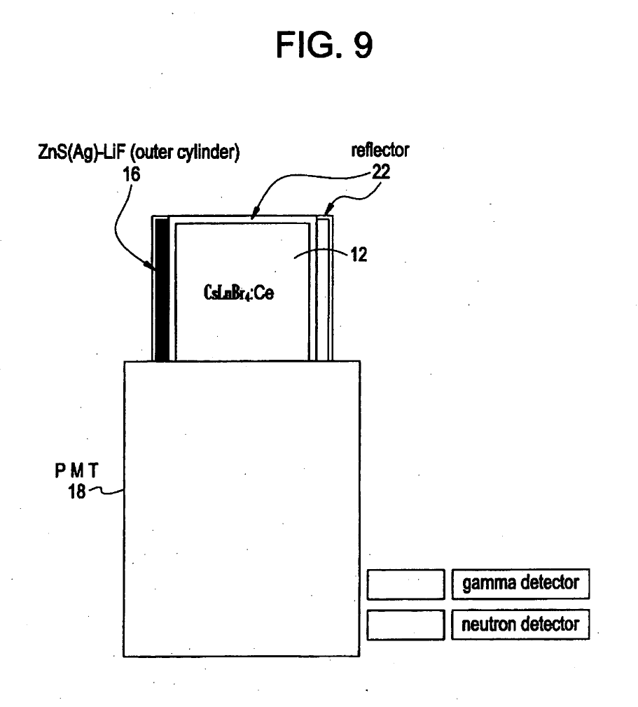

In the figures, A[RE]X₄:T is used as the gamma-scintillator 12 and ZnS(Ag)—LiF is used as the neutron-scintillator 14. Because the wavelength-shifting fibers tend to have significant optical absorption, designs which use multiple fibers are generally preferable because they minimize the total optical path length in the fiber (for a fixed coupling area between the scintillator and the wavelength-shifting fiber). Class 1 designs could also include a design in which both scintillators are optically isolated from each other (by appropriate reflecting material) and directly coupled to the photosensor, as shown in FIG. 9.

The designs using the wavelength shifting fibers allow for the use of neutron scintillators with relatively poor optical properties. All designs would likely benefit from the addition of a neutron moderator (such as paraffin or polyethylene) to thermalize the neutrons before detection (thermal neutrons have a much higher cross section for interaction in most materials than fast neutrons).

In all of the figures and discussion it has been assumed that the neutron-scintillator was on the outside of the detector and coupled to the photosensor with wavelength-shifting fibers in designs that use wavelength-shifting fibers. These assumptions were made for a number of reasons. In most cases, the gamma-scintillator would need to be larger in volume than the neutron-scintillator because the gamma attenuation length is likely to be much longer than the neutron attenuation length. Therefore, it would be convenient to make the neutron-scintillator as a thin layer coupled to the outside of the gamma-scintillator.

Since gamma-rays have relatively long attenuation lengths, most of them will pass through the neutron-scintillator without interacting in it. Therefore, including the neutron-scintillator as the outer layer does not lead to significant gamma-attenuation.

The energy deposited in the neutron-scintillator is large (4.8 MeV, when the lithium reaction is used) compared to the energy deposited in the gamma-scintillator. Therefore, it is more likely that good signal-to-noise can be achieved when the neutron-scintillator is coupled to the photosensor through wavelength-shifting fibers than the case of coupling the gamma-scintillator to the photosensor with wavelength-shifting fibers. Also, for the gamma-scintillator it is desired to have good energy resolution, whereas good energy resolution is not needed for the neutron-scintillator. Therefore, the neutron-detection process is more tolerant of losses in the optical transport system.

Notwithstanding the arguments above, it is intended that this disclosure also covers designs in which the gamma-scintillator is coupled to the photosensor through wavelength-shifting fibers and designs in which the geometry of the two scintillators is varied.

Class 2

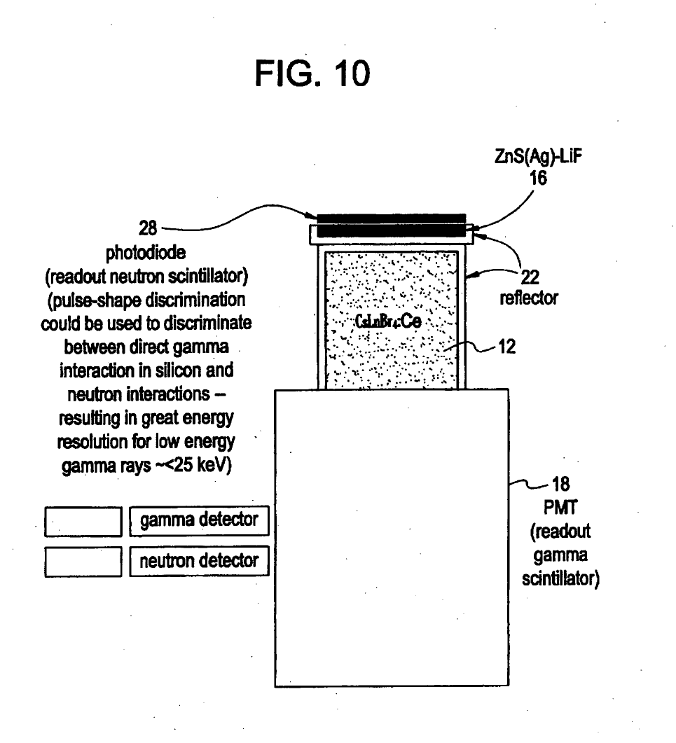

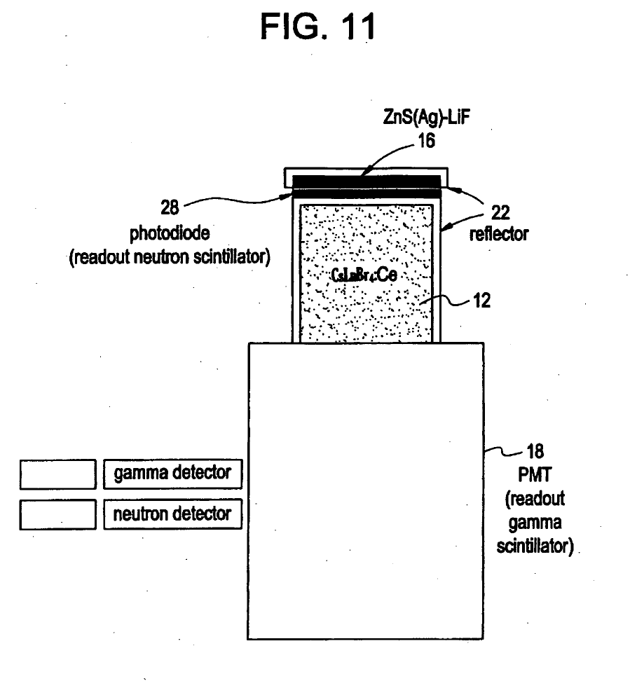

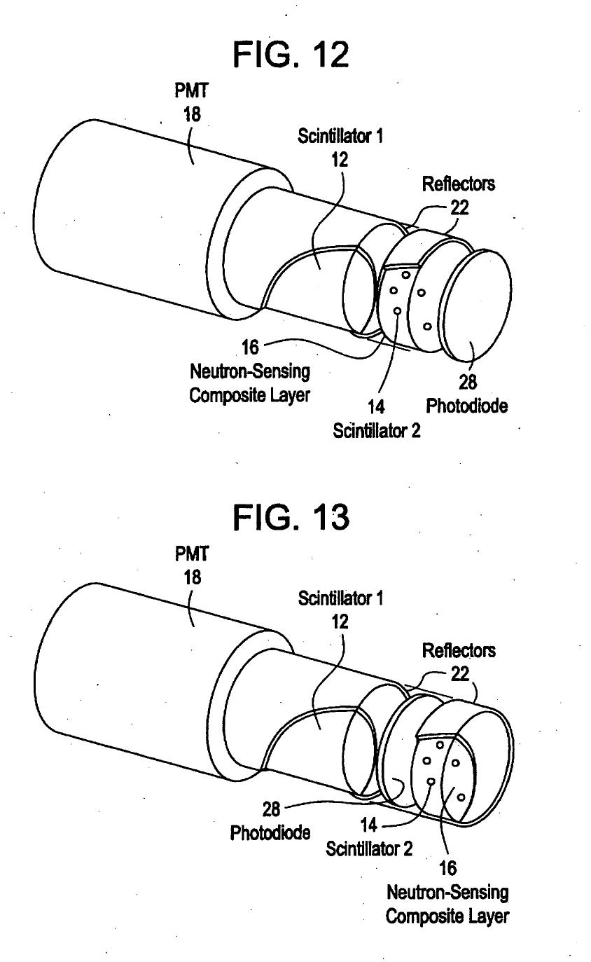

In this class of designs two scintillators are used, one for detecting neutrons and one for detecting gamma-rays, and two separate photosensors are used. Each scintillator is directly coupled to one photosensor and the remaining surfaces of each scintillator are covered with a reflecting material to improve the light collection efficiency. Two such designs are shown in FIGS. 10 and 11. The design shown in FIG. 10 shows inclusion of a photodiode 28, which is used to readout the neutron-scintillator, located on the outer surface of the overall detector, and offers the additional possibility of using the photodiode 28 as a direct conversion detector for low energy (less than about 25 keV, approximately) gamma-rays. Using pulse shape discrimination the direct-conversion events from gamma-rays absorbed in the diode could be discriminated from the signals from neutron interactions in the neutron-scintillator. Additional, embodiments showing use of a photodiode are shown in FIGS. 12 and 13.

In the discussion above photosensor could include (but is not limited to) photomultiplier tubes, photodiodes, avalanche photodiodes, and Geiger-mode diodes.

This second approach overcomes the need for optical coupling between the two scintillators by using novel design concepts. This approach provides several advantages. Since the two scintillators are not optically coupled, the choice of scintillator materials can be made without consideration for interactions between emission in one scintillator and absorption in the other scintillator. This simplifies the selection of scintillator materials and allows for combinations that would not be effective if the two scintillators were optically coupled. It further relieves the constraint that the two scintillators have distinguishable decay times.

Simplification of the electronic hardware and software for distinguishing a neutron from a gamma-ray. In this approach, the neutron and gamma-ray events are distinguished by which photosensor receives a photon signal, rather than by the decay time difference between the two scintillation materials. This relieves the need for more sophisticated time domain analysis of the signal generated in single photosensor in Case 1.

In designs (such as the one shown in FIG. 7) which use a photodiode or avalanche photodiode (APD) on the outer surface of the detector, this approach has the additional advantage of providing high-energy-resolution detection of low energy gamma-rays (less than about 25 keV, approximately) by direct conversion in the photodiode or APD.

Compared to designs in which the two scintillators are optically coupled, this second approach can improve the energy resolution for gamma-ray detection by maximizing the uniformity of the light collection within the gamma-ray scintillator. Eliminating the need for light generated in the neutron-sensing layer to interact in the gamma-scintillator enables more flexibility in gamma-scintillator design which maximizes the opportunity to select materials with more uniform and lower optical absorption at the gamma-scintillator emission wavelengths. This will result in greater light collection uniformity and higher energy resolution.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An activated alkali metal rare earth halide having the formula A[RE]X₄:T, wherein A is an alkali metal, [RE] is a rare earth element, X is a halogen, and T is an activator element.

2. The activated alkali metal rare earth halide of claim 1, wherein the alkali metal comprises cesium.

3. The activated alkali metal rare earth halide of claim 1, wherein the rare earth element comprises yttrium, gadolinium, lanthanum, lutetium, or a combination thereof.

4. The activated alkali metal rare earth halide of claim 3, wherein the rare earth element comprises lanthanum.

5. The activated alkali metal rare earth halide of claim 1, wherein the halogen comprises bromine.

6. The activated alkali metal rare earth halide of claim 1, wherein the activator comprises cerium, bismuth, thallium, or a combination thereof

7. The activated alkali metal rare earth halide of claim 1, wherein the activator is substituted for a portion of the rare earth element and is present in a total amount from about 0.1 mol % to about 20 mol %.

8. The activated alkali metal rare earth halide of claim 7, wherein the activator is substituted for a portion of the rare earth element and is present in a total amount from about 1 mol % to about 10 mol %.

9. The activated alkali metal rare earth halide of claim 6, wherein the activator is substituted for a portion of the rare earth element and is present in a total amount from about 1 mol % to about 10 mol %.

10. The activated alkali metal rare earth halide of claim 1, wherein:
the alkali metal comprises cesium;
the rare earth element comprises lanthanum;
the halogen comprises bromine;
the activator comprises cerium, is present in a total amount from about 1 mol % to about 10 mol %, and is substituted for a portion of the rare earth element.

11. The activated alkali metal rare earth halide of claim 10, having the formula CsLa_{0.95}Ce_{0.05}Br₄.

12. A sensing element activated by radiation comprising:
a first scintillator activated by gamma-radiation; and
a neutron-sensing layer comprising a second scintillator activated by neutron radiation;
wherein the first scintillator comprises an activated alkali metal rare earth halide having the formula A[RE]X₄:T, and wherein A is an alkali metal, [RE] is a rare earth element, X is a halogen, and T is an activator element.

13. The sensing element of claim 12, wherein:
the alkali metal comprises cesium;
the rare earth element comprises lanthanum;
the halogen comprises bromine;
the activator comprises cerium, is present in a total amount from about 1 mol % to about 10 mol %, and is substituted for a portion of the rare earth element.

14. The sensing element of claim 13, wherein the activated alkali metal rare earth halide comprises CsLa_{0.95}Ce_{0.05}Br₄.

15. The sensing element of claim 12, wherein the second scintillator comprises ZnS(Ag)—LiF.

16. The sensing element of claim 14, wherein the second scintillator comprises ZnS(Ag)—LiF.

17. A radiation detector capable of detecting both gamma-rays and neutrons comprising:
a radiation-sensing element comprising a gamma-radiation-sensing first scintillator and a neutron-sensing second scintillator; and
a photosensor;
wherein the gamma-radiation-sensing first scintillator comprises an activated alkali metal rare earth halide having the formula A[RE]X₄:T, and wherein A is an alkali metal, [RE] is a rare earth element, X is a halogen, and T is an activator element.

18. The radiation detector of claim 17, wherein the second scintillator is structured not to excite the first scintillator and is also not excitable by the first scintillator.

19. The radiation detector of claim 17, wherein the detector is hand-held or portable.

20. The radiation detector of claim 17, wherein the first scintillator and the second scintillator are optically connected such that the light from one scintillator passes through the other.

21. The radiation detector of claim 17, wherein the first scintillator and the second scintillator are optically separated.

22. The radiation detector of claim 17, further comprising a photodiode for both reading the second scintillator and for direct detection of low-energy gamma-rays, wherein the detector is structured with pulse-shape discrimination capability to discriminate between low-energy gamma-rays and neutrons.

23. The radiation detector of claim 17, further comprising a moderating material to thermalize neutrons before detection in order to increase detection efficiency.

24. The radiation detector of claim 17, wherein:
the alkali metal comprises cesium;
the rare earth element comprises lanthanum;
the halogen comprises bromine;
the activator comprises cerium, is present in a total amount from about 1 mol % to about 10 mol %, and is substituted for a portion of the rare earth element.

25. The radiation detector of claim 24, wherein the activated alkali metal rare earth halide comprises CsLa_{0.95}Ce_{0.05}Br₄.

26. The radiation detector of claim 17, wherein the second scintillator comprises ZnS(Ag)—LiF.

27. The radiation detector of claim 25, wherein the second scintillator comprises ZnS(Ag)—LiF.

28. The radiation detector of claim 17, wherein:
the second scintillator is structured not to excite the first scintillator and is also not excitable by the first scintillator;
the detector is hand-held or portable;
the detector further comprises a photodiode for both reading the second scintillator and for direct detection of low-energy gamma-rays, wherein the detector is structured with pulse-shape discrimination capability to discriminate between low-energy gamma-rays and neutrons;
the detector further comprises a moderating material to thermalize neutrons before detection in order to increase detection efficiency;
the activated alkali metal rare earth halide comprises CsLa_{0.95}Ce_{0.05}Br₄; and
the second scintillator comprises ZnS(Ag)—LiF.
